(19) United States
(12) Patent Application Publication
(10) Pub. No.: US 2014/0331159 A1
(43) Pub. Date: Nov. 6, 2014

(54) Methods And Systems For Generating And Displaying Data Display Elements

(71) Applicant: Adrian Hillary, Effingham (GB)

(72) Inventor: Adrian Hillary, Effingham (GB)

(21) Appl. No.: 14/235,673

(22) PCT Filed: Jul. 26, 2012
(86) PCT No.: PCT/GB2012/051803

§ 371 Date: Jul. 3, 2014

(30) Foreign Application Priority Data
Jul. 28, 2011 (GB) 1112983.0

(51) Int. Cl. G06F 3/0486; G06F 17/22; G06F 17/24

(52) U.S. Cl. CPC G06F 3/0486; G06F 17/248; G06F 17/2247
USPC 715/769; 715/764

(57) ABSTRACT

A method of generating and displaying data display elements in a computer system. A data display element comprises a standardised data set and a display configuration for the data set. The standardised data set comprises a set of data values, and the display configuration defines how the data values making up the standardised data set are displayed. If a request from a user made using the graphical representation of a first data display element to combine the first data display element with a second data display element is received, a combined data display element is generated. The combined data display element comprises a combined standardised data set generated by combining the sets of data values of the data sets of the first and second data display elements, and a display configuration for the combined standardised data set derived from the display configurations of at least one of first and second data display elements.

### FIELD OF THE INVENTION

The present invention concerns methods and systems for generating and displaying data display elements. More particularly, but not exclusively, this invention concerns shareable, standardised and interactive data display elements that can be combined to produce new shareable, standardised and interactive data display elements.

### BACKGROUND OF THE INVENTION

Web sites are commonly used to display sets of data. For example, Internet web sites may display share prices or currency exchange rates, either with their current values or as they have changed over time. Government web sites such as that of the UK Office of National Statistics (statistics.gov.uk), or local council web sites, may show various sets of data, for example data relating to the birth rates, employment statistics, crime rates and the like. Web interfaces are often used to allow users to query, view and manipulate data stored in the databases of local applications via a local intranet site, such as accounting software, records systems and the like. The data may be displayed in the form of tables, bar charts, line graphs, or in various other formats.

An architecture of a known system 1 for displaying information on web sites is shown in FIG. 1. Various organisations have computer systems 10 that store data in databases 11. The data in the databases 11 is used by web servers 12 to generate web pages for intranet sites 13, or web sites 14 available over the Internet 15. The web pages are served to and displayed by web browsers 16. Commonly data will be displayed in a web page using a combination of HTML, CSS and JavaScript, as a pre-generated graphic, or in some other proprietary format.

A disadvantage of this architecture is that while the web browsers are suited for displaying and manipulating data provided in web pages, and manipulating data using the web site itself, the displayed data is not provided in a format in which it can easily be extracted or manipulated outside of the web page or web site. As a consequence, it may be difficult or impossible to vary the format in which the data is displayed, and the data cannot be easily be combined with other sets of data from the same web site, or particularly with sets of data from different web sites.

Other, non-web-based data displaying computer systems such as spreadsheets, statistical analysis applications, business intelligence applications and the like suffer from similar disadvantages in that data from different systems or even within the same system cannot be easily shared, displayed, manipulated.

The present invention seeks to mitigate the above-mentioned problems. Alternatively and/or additionally, the present invention seeks to provide an improvement to the sharing, distribution and display of data on computer systems.

### SUMMARY OF THE INVENTION

In accordance with a first aspect of the present invention there is provided a method of generating and displaying data display elements in a computer system, wherein a data display element comprises a standardised data set and a display configuration for the data set, wherein the standardised data set comprises a set of data values, and wherein the display configuration defines how the data values making up the standardised data set are displayed, the method comprising the steps of:

displaying a graphical representation of a first data display element using the data set and display configuration of the first data element;

receiving a request from a user made using the graphical representation of a first data display element to combine the first data display element with a second data display element;

generating a combined data display element comprising a combined standardised data set and a display configuration for the combined standardised data set, wherein the combined standardised data set is generated by combining the sets of data values of the data sets of the first and second data display elements, and wherein the display configuration for the combined standardised data set is derived from the display configurations of at least one of first and second data display elements;

displaying a graphical representation of the combined data display element using the data set and display configuration of the combined data display element.

As the user can use the displayed graphical representation of the first data display element to provide the request that it be combined with the second data display element, this allows an easy and intuitive way of requesting that the data display elements be combined. Then, as the data set in each data display element is standardised, this standardisation allows the data to be combined without requiring any further input from the user, as the standard defines how the data should be combined. The display configurations for the data display elements can be similarly combined without further input from the user.

Advantageously, the user request to combine the first and second data display elements is made by the user dragging the graphical representation of the second data display element onto the graphical representation of the first data display element. Alternatively, the user request to combine the first and second data display elements is made by the user dragging a saved copy of the second data display element onto the graphical representation of the first data display element.

The method may further comprise the steps of:

receiving a request from a user made using the graphical representation of a data display element to save a copy of the displayed data display element in a location;

saving a copy of the data display element in the location. Advantageously, the user request to save a copy of the data display element is made by the user dragging and dropping the graphical representation of the data display element onto the location to which the copy is to be saved.

The method may further comprise the steps of:

receiving a request from a user made to display a graphical representation of a saved copy of a data display element;

displaying a graphical representation of the data display element using the data set and display configuration of the data display element. Advantageously, the user request to display the data display element is made by the user dragging and dropping the saved copy of the data display element onto the location where it is to be displayed.

Advantageously, the graphical representations of the data display elements are displayed in a web page. In this case, preferably the generation and display of the data display elements is implemented using JavaScript.

Preferably, the user can send requests to the computer system to change the display configurations of the data display elements.

Advantageously, the standardised data set of at least one data display element is provided by a remote server, and the data display element comprises a link to that server. Alternatively, the data values making up the first data set may be stored within a data display element itself. Advantageously, the data values are copied into a data display element containing a link to an external source when the data display element is to be used when the link is not available. Preferably, the method of this aspect of the invention further comprises the step of the step of updating the data values of the standardised data set by querying the linked server. This allows the data values displayed by the data object to be kept up to date.

The display configuration of at least one data display element defines that only a portion of the data values making up the standardised data set of the data display element are to be displayed. This allows the user to display data values that are of particular interest.

Advantageously, the method of this aspect of the invention further comprising the steps of:

obtaining a template data display element comprising a display configuration for a standardised data set, but no standardised data set;

obtaining a standardised data set from a server;

including the standardised data set in the template data display element to generate a data display element. The template data display elements can be used by a user to display data values from a data set not included in a data display element, for example from a web site that provides only data sets. The template data display elements can also be used by a user to display data values from a data set already included in a data display element in a different way.

Advantageously, the standardised data set of a data display element further comprises dimensions for the standardised data set, and the step of generating the combined data display element comprises the step of determining compatible dimensions from the first and second data display elements. By having sets of data values within the data display elements described by dimensions (which as in data warehousing may be numerical or non-numerical), this means that when data display elements are combined, the dimensions can be considered to determine which sets of data values are compatible with each other, i.e. can be combined together. In this case, preferably the standardised data set of the first data display element comprises a first set of data values described by a first dimension set, the standardised data set of the second data display element comprises a second set of data values described by a second dimension set compatible with the first dimension set, and wherein the combined standardised data set of the combined data display element comprises a third set of data values described by a third dimension set, and the third set of data values is derived from the first and second set of data values, and the third dimension is compatible with the first and second dimension sets. Thus, the combined data display element comprises a set of data values derived by combining sets of data values from the original first and second data display elements, which have been identified as being compatible on the basis of the first and second dimensions with which they are described. The first and second dimensions may be the same, or may be different but compatible. The set of data values in the combined data display element is itself described by a third dimension set which is compatible with the original first and second dimension set. The third dimension set may be the same as the first dimension set and/or second dimension set, or may be different but compatible. Each pair of compatible sets of data values from the first and second data display elements may be combined, or only one or more pairs, for example only sets of data values that are indicated by the metadata to be primary, independent or the like. Further, the first and second dimension sets may be compatible only for a subset of dimensions, or dimensions may not be “directly” compatible but may require some conversion/aggregation or the like prior to combination.

Preferably, the standardised data set of a data display element further comprises units of measure for the data values of the standardised data set, and the display configuration of the combined data display element is derived by converting the units of measure of the data values of the data sets of the first and second data display elements to a common unit of measure. This allows the data values from the data sets to be easily compared. The conversion rate used when converting the units of measure may be provided by a remote server. In this case, advantageously the method of this aspect of the invention further comprises the step of updating the conversion rate by querying the remote server. This allows the conversion rate used to be kept up to date.

Preferably, the standardised data set of a data display element contains categorisation, grouping and/or hierarchies for the data values of the standardised data set.

In accordance with a second aspect of the invention there is provided a computer system for generating and displaying data display elements, wherein a data display element comprises a standardised data set and a display configuration for the data set, wherein the standardised data set comprises a set of data values, and wherein the display configuration defines how the data values making up the standardised data set are displayed, and wherein the computer system is arranged to:
display a graphical representation of a first data display element using the data set and display configuration of the first data element;
receive a request from a user made using the graphical representation of a first data display element to combine the first data display element with a second data display element;
generate a combined data display element comprising a combined standardised data set and a display configuration for the combined standardised data set, wherein the combined standardised data set is generated by combining the sets of data values of the data sets of the first and second data display elements, and wherein the display configuration for the combined standardised data set is derived from the display configurations of at least one of first and second data display elements;
display a graphical representation of the combined data display element using the data set and display configuration of the combined data display element.

Advantageously, the user request to combine the first and second data display elements is made by the user dragging the graphical representation of the second data display element onto the graphical representation of the first data display element. Alternatively, the user request to combine the first and second data display elements is made by the user dragging a saved copy of the second data display element onto the graphical representation of the first data display element.

The system may be further arranged to:

receive a request from a user made using the graphical representation of a data display element to save a copy of the displayed data display element in a location;

save a copy of the data display element in the location. Advantageously, the user request to save a copy of the data display element is made by the user dragging and dropping the graphical representation of the data display element onto the location to which the copy is to be saved.

The system may be further arranged to:

receive a request from a user made to display a graphical representation of a saved copy of a data display element;

display a graphical representation of the data display element using the data set and display configuration of the data display element. Advantageously, the user request to display the data display element is made by the user dragging and dropping the saved copy of the data display element onto the location where it is to be displayed.

Advantageously, the system is arranged to display the graphical representations of the data display elements in a web page. In this case, preferably the system is arranged to implement the generation and display of the data display elements using JavaScript.

Advantageously, the standardised data set of at least one data display element is provided by a remote server, and the data display element comprises a link to that server. Alternatively, the system is further arranged to update the data values of the standardised data set by querying the linked server.

The display configuration of at least one data display element may define that only a portion of the data values making up the standardised data set of the data display element are to be displayed.

Advantageously, the system is further arranged to:

receive a template data display element comprising a display configuration for a standardised data set, but no standardised data set;

obtain a standardised data set from a server;

include the standardised data set in the template data display element to generate a data display element.

Advantageously, the standardised data set of a data display element further comprises dimensions for the standardised data set, and the system is further arranged to generate the combined data display element by determining compatible dimensions from the first and second data display elements. In this case, preferably the standardised data set of the first data display element comprises a first set of data values described by a first dimension set, the standardised data set of the second data display element comprises a second set of data values described by a second dimension set compatible with the first dimension set, and the combined standardised data set of the combined data display element comprises a third set of data values described by a third dimension set, and the third set of data values is derived from the first and second set of data values, and the third dimension is compatible with the first and second dimension sets.

Preferably, the standardised data set of a data display element further comprises units of measure for the data values of the standardised data set, and the combination unit is arranged to derive the display configuration for the combined data display element by converting the units of measure of the data values of the data sets of the first and second data display elements to a common unit of measure.

The conversion rate used when converting the units of measure may be provided by remote server. In this case, advantageously the system is further arranged to update the conversion rate by querying the remote server.

In accordance with a third aspect of the invention there is provided a data file for a data display element on a computer system for use in any preceding claim, comprising:

a standardised data set comprises a set of data values;

a display configuration for the standardised data set, wherein the display configuration defines how the set of data values making up the standardised data set is to be displayed.

In accordance with a fourth aspect of the invention there is provided a server arranged to store and serve on request data display elements as described above. Advantageously, the server is further arranged to store and serve on request template data display elements comprising a display configuration for a data set, but no standardised data set. Advantageously, the server system further comprises a data store storing data values, and further arranged to serve, in response to a request for a standardised data set, a set of data values from the data store to make up the standardised data set.

In accordance with a fifth aspect of the invention there is provided a computer program product arranged, when executed, to perform any of the methods described above.

In accordance with a sixth aspect of the invention there is provided a computer program product arranged, when executed on a computer system, to provide any of the computer systems described above.

In accordance with a seventh aspect of the invention there is provided a computer program product arranged, when executed on a computer system, to provide any of the servers described above.

In accordance with a eighth aspect of the present invention there is provided a method of generating in a computer system a data display file for display by a computer, comprising the steps of:

obtaining a plurality of data display files, each data display file comprising a standardised data set provided by a server and a display configuration for the data set, wherein the standardised data set comprises a set of data values, and wherein the display configuration defines how the data values making up the standardised data set are to be displayed;

in response to a request by a user of the computer system to combine first and second data display files, generating a combined data display file comprising a combined standardised data set and a display configuration for the combined standardised data set;

wherein the combined standardised data set is generated by combining the sets of data values of the data sets of the first and second data display files;

and wherein the display configuration for the combined standardised data set is derived from the display configurations of at least one of the first and second data display files.

The use of data display file comprising a standardised data set and a display configuration for the data set allows data to be easily displayed, manipulated and combined. The data display files may be provided by web sites, or shared by users by e-mail, for example; as they are in essence self-contained files this allows them to be easily shared. The data display files may also be stored for later use. However, as the data sets in the data display files are in standardised form, the data sets from two data display files can easily be combined, even when they are obtained from entirely different sources. Further, the use of a display configuration allows the data in a data display object to be easily displayed, as the display is simply done in accordance with the definition given by the display configuration. The combination of the use of standardised data sets and display configuration in particular has the advantage that the data from two data display files that are combined together can be displayed together, as the standardised form for the data means that the display configuration for one initial display configuration can be used when displaying the originating from itself, and also the data originating from the other data display object.

In accordance with a ninth aspect of the invention there is provided a computer system for generating a data display file for display by a computer, comprising:

a store comprising a plurality of data display files, each comprising a standardised data set provided by a server and a display configuration for the first data set, wherein the standardised data set comprises a set of data values, and wherein the display configuration defines how the data values making up the standardised data set are to be displayed;

a user interface arranged to receive a request from a user of the computer system to combine first and second display files;

a combination unit arranged, in response to such a request, to generate a combined data display file comprising a combined standardised data set and a display configuration for the combined standardised data set;

wherein the combined standardised data set is generated by combining the sets of data values of the data sets of the first and second data display files;

and wherein the display configuration for combined standardised data set is derived from the display configurations of at least one of the first and second data display files.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 is a schematic diagram of an architecture of a known system for displaying information on web sites;

FIG. 2 shows an architecture of a system in accordance with a first embodiment of the present invention;

FIG. 3 shows the structure a SIBDO of the embodiment of FIG. 2;

FIG. 4 shows a SIBDO Exchange Server;

FIG. 5 shows examples of VISOs and the construction of a VISO Trace;

FIGS. 6a to 6e show further examples of VISOs;

FIGS. 7a and 7b show examples of combining and sharing SIBDOS;

FIG. 8 is a further schematic diagram of the architecture of the system in accordance with the embodiment of the invention.

### DETAILED DESCRIPTION

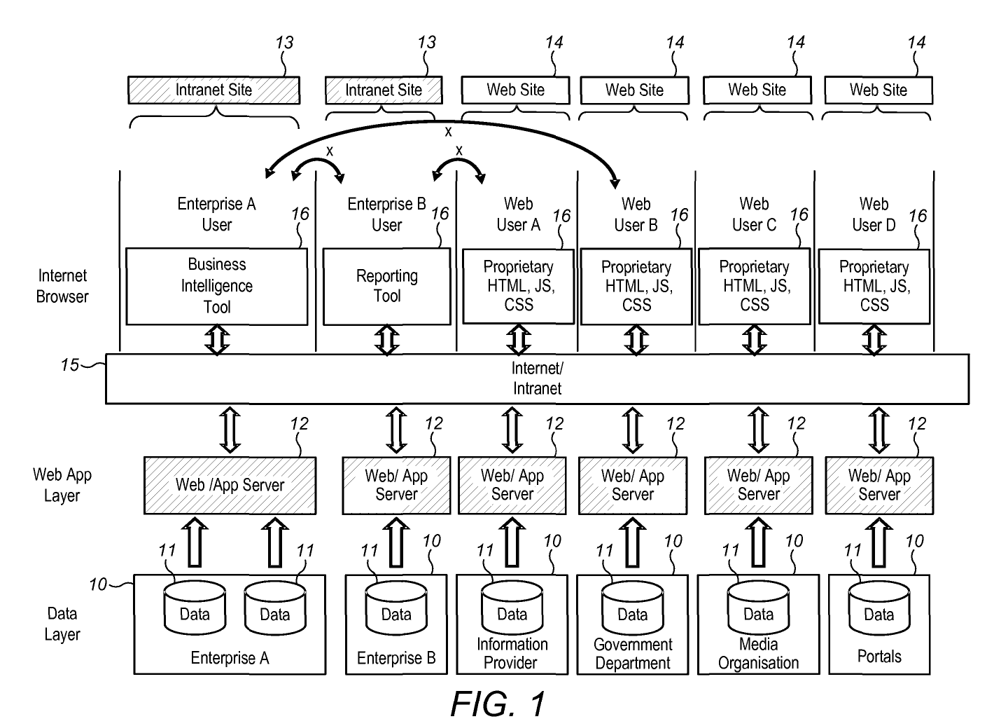

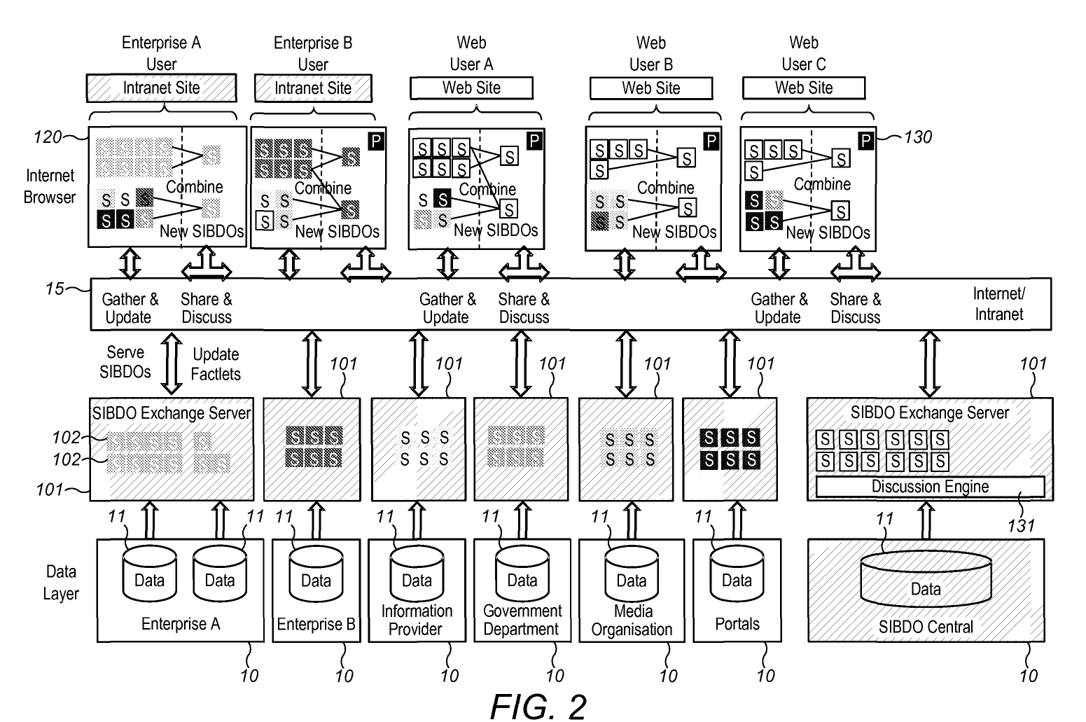

The architecture of a system 100 in accordance of a first embodiment of the present invention is shown in FIG. 2. As in the known architecture shown in FIG. 1, various organisations have computer systems 10 that store data on databases 11. Each system 10 is connected to a corresponding SIBDO Exchange Server 101. The data in the database(s) 11 of a system 10 is used by the corresponding SIBDO Exchange Server 101 to provide one or more data objects knows as “SIBDO”s (Sharable Interactive Bindable Data Objects) 102.

While in the following the use of SIBDOs is described primarily with reference to a client-server type arrangement of a SIBDO Exchange Server and user device, it will be appreciated that a centralised system is not required, and SIBDOs can equally (indeed advantageously) be used in a decentralised system comprising several servers and other devices that interact in a peer-to-peer fashion. In addition to SIBDO Exchange Servers, the devices may include “producers”, which take stored data or gather external data and use this to produce SIBDOs; “aggregators”, which use existing SIBDOs to produce new SIBDOs; “reporters”, which track changes to data/SIBDOs and provide alerts to other devices; and devices that combine some or all of these functionalities. Further, as the SIBDOs provide a standardised structure for the data they contain and the way it is displayed, devices can use the SIBDOs even when operating independently and disconnected from the system as whole.

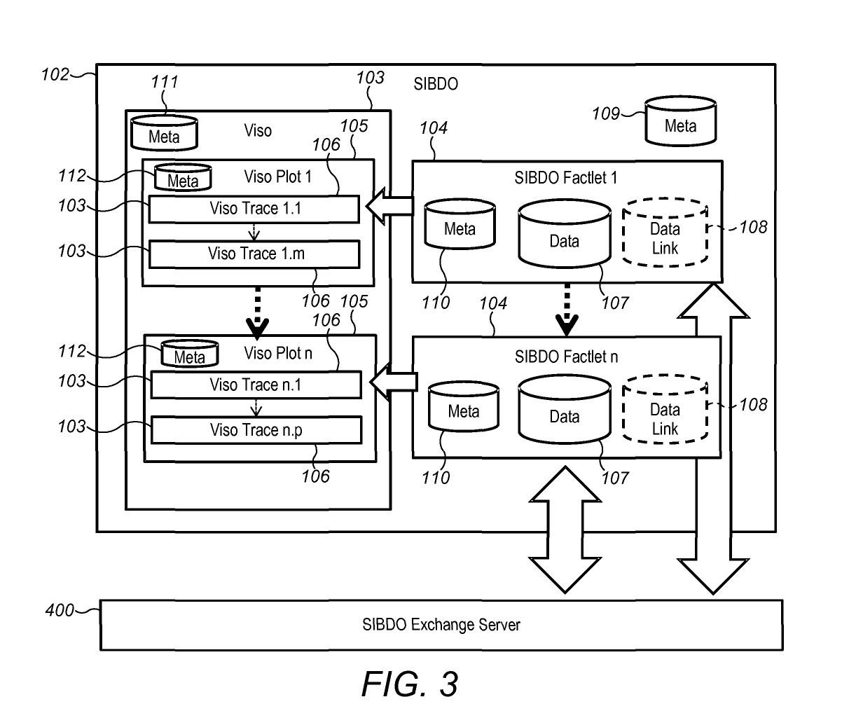

The SIBDOs 102 are shown in more detail in FIG. 3. A SIBDO 102 is an object containing a set of data for display, manipulation and the like. In the present embodiment, a SIBDO 102 is a single file that can be exchanged between users for discussion. In addition, a SIBDO 102 can be moved/copied by a user between web sites, applications and the like, to allow it to be manipulated, combined with SIBDOs originating from other web sites/applications, and so on.

A SIBDO 102 will have a filename of the general form <filename.sbd>. The internal components of the SIBDO 102 are not easily accessible to the user, and are encoded for reasons of performance and reducing file size. Sensitive data can be optionally encrypted within the SIBDO 102 if required and only accessed within a compatible secure environment.

In a particularly advantageous embodiment, the SIBDOs are written in a custom language, and applications and/or browser pages are provided to allow them to be used. A browser page may use a JavaScript library that is loaded with the page to provide the functionality to display, manipulate and store the SIBDOs. A SIBDO will be displayed in the web page using HTML code of the form:

<div class=“sibdo” data-url=“Sample/Sibdo_{—}123.sbd” style=“width: 300px; height: 100px;” ></div>

where the data-url attribute points to a local or remotely stored SIBDO. This HTML code results in a call to the JavaScript library. In alternative embodiments, browser plug-ins may be used.

A SIBDO 102 contains three types of components:

(i) One or more SIBDO “Factlets” 104. A SIBDO Factlet contains data 107 which is obtained from the data in the database(s) 11 of the system 10 corresponding to the SIBDO Exchange Server 101 which provided the SIBDO 102. The SIBDO Factlet has metadata 110 that includes the dimensions for the data 107. A dimension may for example be for numerical values. For example, a SIBDO 102 containing historical stock value data valued in GBP by day would include the dimensions “day” and “GBP”. Alternatively, a dimension may be for non-numerical values, for example a set of currencies, stocks, products or the like. Using the same example above, the metadata 110 for SIBDO 102 would contain a dimension for the stocks for which daily GBP values were given.

In data warehousing terms, a SIBDO Factlet 104 is a compressed standardised form of a star schema configuration to allow rapid combination with other SIBDO Factlets 104. Data in each SIBDO Factlet 104 can be dimensioned by one or more dimensions. The most common form of SIBDO Factlet 104 would be dimensioned by at least the “time dimension”. The values held in the SIBDO Factlet 104 can be held at different levels of granularity. Values can be pre-aggregated for performance reasons. For example, the SIBDO Factlet 104 may contain data at a “month” granularity as well as the same data aggregated to financial quarters. Pre-aggregation is executed by the SIBDO Exchange Server 101. Other embodiments of a SIBDO 102 could be dimensioned by subjects in addition to time.

In preferred embodiments, a SIBDO contains a description of the data in the Factlet(s) it contains, defined using a published ontology. (An ontology is a pre-defined vocabulary for use describing and reasoning about a particular domain. For example, ontologies exist for describing financial data, products, library contents, and the like.) The ontology may be provided specifically for use by SIBDOs, and for example made available by a SIBDO Exchange Server, or may be an already-existing ontology. The use of an ontology means the properties of and relationships between SIBDOs can be reasoned about.

A SIBDO Factlet 104 is identified with its own unique identifier (UID). Relations between SIBDO Factlets can then be represented using the UIDs. This can be used to represent hierarchical relationships between SIBDO Factlets 104 within a SIBDO; for example, the SIBDO 102 can contain a record of the SIBDO Factlets (if any) from which the SIBDO Factlet 104 is derived.

The SIBDO Factlet 104 can contain actual data values, or only a link 108 to the data values which are stored on a SIBDO Exchange Server 101. As mentioned above, the data in a SIBDO Factlet 104 may be encrypted if desirable for security purposes.

As described below, SIBDO Factlets can be derived by combining existing SIBDOs obtained from other sources using a graphical user interface. However, Factlets may also be defined directly using formulae. For example, a SIBDO Factlet may be defined as the sum or average of data from other Factlets. This would result in the referenced Factlets being automatically stored within the SIBDO, though the referenced Factlets would not necessarily be displayed. A Factlet might also be created directly from data stored within a spreadsheet, for example by dragging the spreadsheet into a SIBDO creating application or web page.

The data in a SIBDO Factlet can also be created and amended directly. The user interface can display a spreadsheet-type display of the data in the SIBDO Factlet, allowing data to be added, amended and/or deleted as required by a user.

(ii) Each SIBDO Factlet 104 contains metadata 110. The metadata 110 includes for example the origin of the data (e.g. the name of the company or individual that provided the data originally), the date the SIBDO Factlet 104 was created and last updated, permissions defining how the SIBDO Factlet 104 may be used, and so on.

(iii) Each SIBDO 102 contains one VISO (Visual Object) 103. A VISO is a visualisation of data in a SIBDO 102: it consists of VISO “Plots” 105 that are further broken down into VISO “Traces” 106. The VISO define how the data in the SIBDO Factlets is to be displayed, as described in detail below. Each SIBDO Factlet 104 contained in or linked to by the SIBDO 102 has a corresponding VISO Plot 105, which defines how the data given by the SIBDO Factlet is to be displayed.

In addition, a SIBDO may act as a template for data visualisation by containing a series of VISO Plots 105 but no corresponding SIBDO Factlets 104. In other words, the SIBDO contains a VISO that defines how data is to be displayed, but no data. These “template” SIBDOs can be used within an application framework to build SIBDO enabled websites, or can be provided with data (or links to data) so that they can be used for comparison and analysis of data.

A VISO 103 also contains various pieces of metadata 111. The metadata includes information regarding the “canvas” on which the VISO Plots 105 are to appear, in other words the basic appearance of the VISO as a whole. So for example, the metadata 111 will define the size, background colour, axis tick marks, axis labels and so on for canvas on which the VISO Plots 105 are displayed.

In a preferred embodiment, SIBDOs retain a full history of changes made to them, giving a version history. The version history may be stored as verifiable data, e.g. using hash chains and digital signatures stored within the SIBDO. Any changes may be transmitted back to the SIBDO Exchange Server from which the SIBDO originates. SIBDOs may also contain narratives, i.e. stored text comments/annotations relating to elements within the SIBDO (e.g. data sets or points).

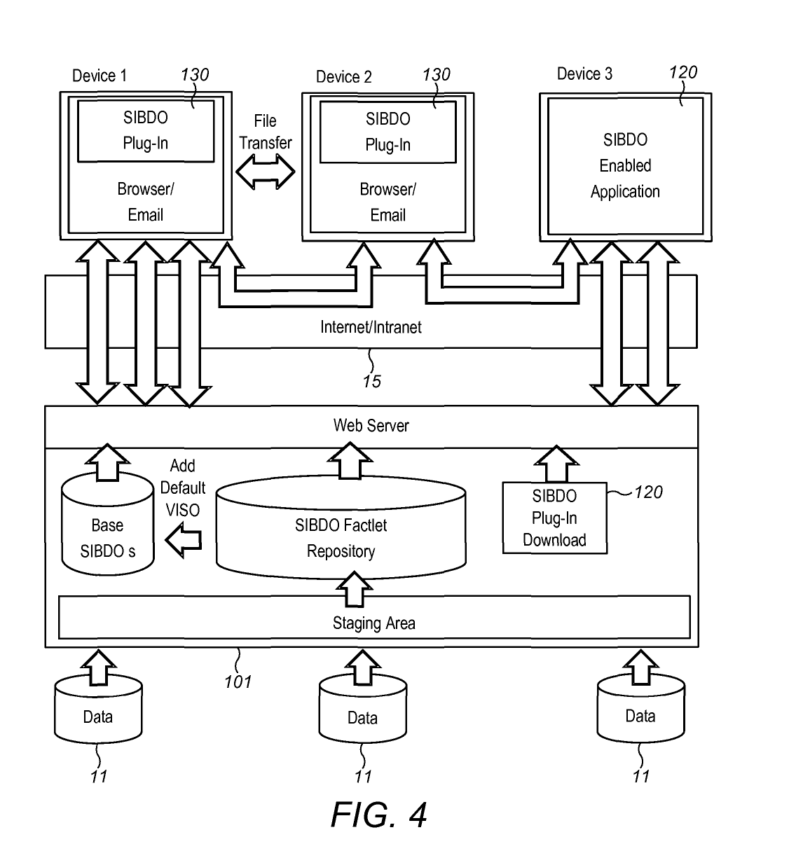

A SIBDO 102 in its most basic form consists of one SIBDO Factlet 104 and one corresponding visualisation of that Factlet (a VISO 103). This is also known as a “base” SIBDO 112, and these are discussed further below with reference to FIG. 4. The base SIBDOs are the basic units that are distributed by the SIBDO Exchange Server 101.

However, in advantageous embodiments there may also be “container” SIBDOs, which contain other SIBDOs (which may themselves be also container SIBDOs). Thus, a SIBDO represented by a single file, and intuitively considered to be a single object, may in fact contain multiple SIBDOs, which may be nested. This allows related sets of data to be grouped together; for example a container SIBDO for company share data might contain multiple container SIBDOs each relating to data for a particular stock exchange (USA, FTSE, Tokyo etc.), with each of those container SIBDOs containing a SIBDO for each company on that exchange.

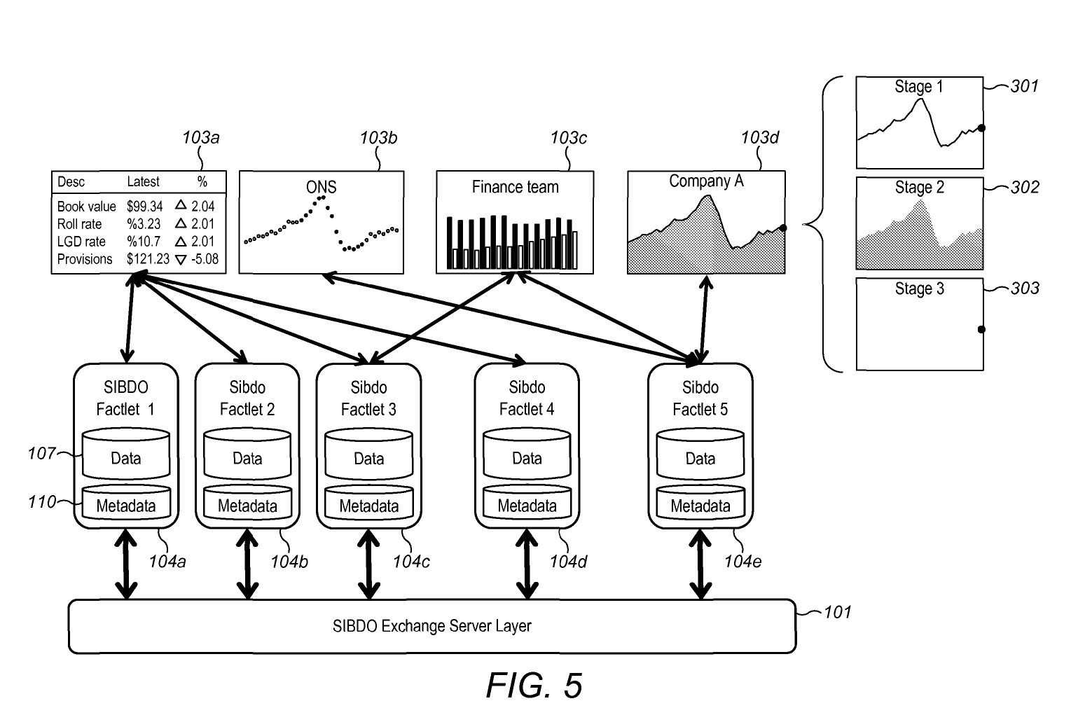

FIG. 5 shows examples of the rendering of data as defined by VISOs 103a to 103d of SIBDOs which comprise combinations of underlying SIBDO Factlets 104a to 104e. VISO 103a is for a SIBDO comprising SIBDO Factlets 104a to 104d. The SIBDO Factlet metadata includes multiple items, including (amongst other things) a description, origin of the data, updated date, permissions and so on. The VISO 103a defines that items from the SIBDO Factlets are displayed as a list. Notably, the SIBDO Factlets includes various data values not displayed by the VISO 103a. In this case, the SIBDO Factlet 104a contains historical value data, while the VISO 103a defines that only the latest value is displayed. Further, the SIBDO Factlet contains data for items other than those displayed by the VISO 103a; in other words, the VISO 103a defines a subset of the items in the SIBDO Factlet 104 which are to be displayed.

As another example, VISO 103b displays data values from the SIBDO Factlet 104e only. The VISO 103b defines that the data is displayed as a series of points making up a graph, the range of data displayed, the scale of the axes of the graph, and that a portion of the data is to be highlighted in a different colour.

As a final example, VISO 103c displays data values from SIBDO Factlets 104c and 104e. The VISO 103c defines (amongst other things) that the data is displayed as a bar chart with the data values from the two SIBDO Factlets side by side.

The rendering of VISO 103d is now described, again with reference to FIG. 5. As mentioned above, a VISO includes a VISO Plot for each SIBDO Factlet in the SIBDO, and metadata that includes information regarding the canvas on which the VISO Plots appear. VISO 103d comprises a single VISO Plot for the data values from SIBDO Factlet 104e. The VISO Plot is further subdivided into a plurality of VISO Traces.

The first step in the rendering of the VISO 103d the display of the canvas (or “panel”) which provides the background for the VISO. The VISO metadata gives the size of the VISO, its background colour, and any details of labels and axes.

Next, a first VISO Trace of the VISO Plot is drawn on the canvas. The VISO Trace defines that the data values of the SIBDO Factlet 104e should be drawn as a line of colour “dark blue”, as shown by the graphic 301. The second VISO Trace is then drawn on the canvas; this draws the same data, but in this case as an area of colour “light blue”, as shown by the graphic 302. Finally the third VISO Trace draws the last point of the data range, in other words a single point, as a dot of colour “dark blue”, as shown by the graphic 303.

The combination of drawing the canvas and each of the VISO Traces gives the completed VISO 103d.

Container SIBDOs are rendered by rendering (recursively if necessary) each of the SIDBOs they contain.

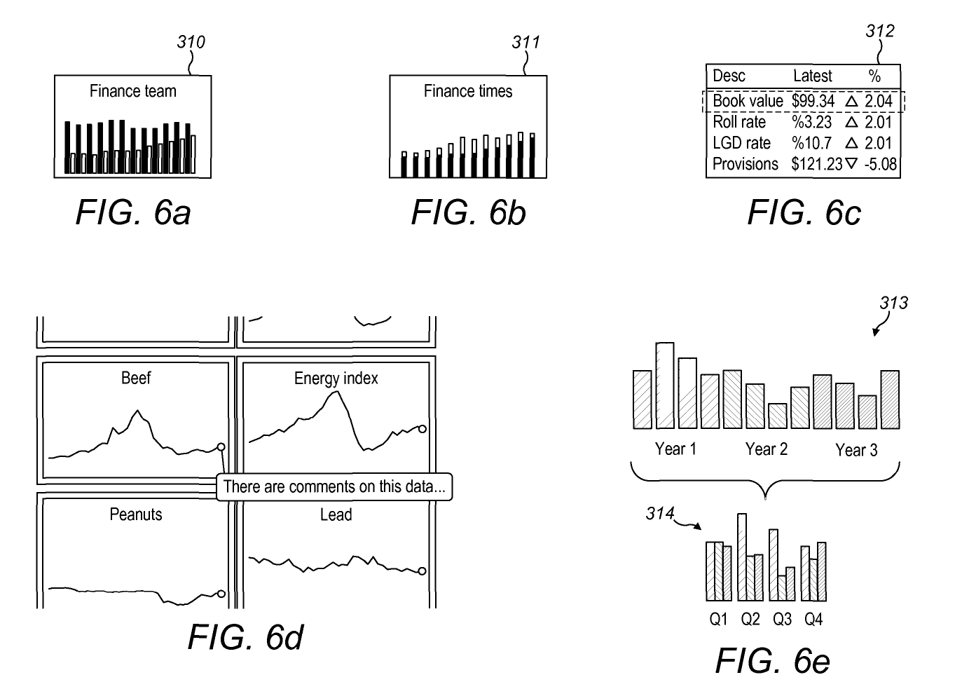

FIGS. 6a to 6e show further examples of VISOs 103. FIG. 6a shows a VISO 310 which displays the data values of two SIBDO Factlets 107 as bar charts offset by a number of pixels to create a “staggered” effect. FIG. 6b shows a VISO 311, which is similar to the VISO 310 except that the bar charts are not offset.

FIG. 6c shows a VISO 312 which displays a plurality of individual SIBDOs that are contained within a single outer SIBDO. Each SIBDO as described above contains its own VISO to displaying the data values of an associated SIBDO Factlet of that SIBDO. The VISO 313 then displays the data values of the underlying SIBDO Factlets using their associated individual VISOs. In this example the individual VISOs are stacked on top of each other and show a description, latest value, red or green indicator arrow and percentage change. The individual SIBDOs can be extracted individually and combined with other SIBDOs.

In an advantage embodiment shown in FIG. 6d, individual VISO Traces 106 can be marked with comments by users. The comments, originator of the comment, date, time and data values the comments apply to are held in the individual metadata for the VISO Plot.

As shown in FIG. 6e, a VISO can take multiple sets of data values from a single SIBDO Factlet 104 and juxtapose them. VISO 314 displays data values sale volumes for three years arranged by quarter, where the data values come from a single SIBDO Factlet 314 containing sales volume over time.

VISOs can contain and combine many types of visualisation. For example, VISOs can display data in tabular as well as graphical format. Alternatively a VISO could overlay spatial data on a map representation.

The use of SIBDOs 102 is now described with reference to FIG. 2. A user can manipulate SIBDOs using a dedicated application 120, or via a web application/browser plug-in 130, which provides a “drag and drop” interface for the user. Via the interface, the user can link to one or more of the SIBDO exchange servers 101, in order to access the SIBDOs 102 they provide.

The dedicated application 120 provides one or more SIBDOs 102 embedded in one or more web pages. Some of these SIBDOs can be “template” SIBDOs, which as described above are SIBDOs comprising a VISO but which do not contain a reference to any SIBDO Factlet. These are used as initially empty analysis “scratch pad” areas on which to drag SIBDOs containing data. When the interface is instructed by the user to link a SIBDO to a particular template SIBDO, this creates a new SIBDO based on the VISO of the template SIBDO, but with a reference to the SIBDO Factlets of the original SIBDO. The new SIBDO can then be used to display the data in the original SIBDO according to the visualisation given by the VISO of the template SIBDO. New SIBDOs can be saved at any point and exchanged by the user in the same way that other computer files (for example JPEG files for images) are exchanged, for example by email or via a discussion web site. In an advantageous embodiment the application 120 has its own discussion capability 131 to allow structured discussion of information within an enterprise.

The SIBDO Exchange Server 101 is shown in more detail in FIG. 4. The SIBDO Exchange Server 101 comprises a store of SIBDO Factlets, and is able to map data values from external data sources 11 to the SIBDO Factlets in the store.

The SIBDO Exchange Server 101 further comprises a store of base SIBDOs (as described above) for distribution via an integral web server to SIBDO enabled applications and SIBDO plug-ins. The base SIBDOs are created by the SIBDO Exchange Server 101 using the stored SIDBO Factlets.

The SIBDO Exchange Server 101 is further able, in response to a request received via the web server, to provide updated data values for the SIBDO Factlets of external SIBDOs (i.e. a SIBDO stored on another machine), where those SIBDO Factlets 104 that originate from that particular SIBDO Exchange server 101. This updating occurs when the SIBDO “docks”, in other words when the SIBDO has a network connection to the SIBDO Exchange Server 101. This allows the data from the SIBDO to be kept up to date with the data provided by the SIBDO Exchange Server 101. As mentioned above, a SIBDO may contain actual data values that are updated, or only a link to a SIBDO Exchange Server which provides the data values when required.

It can be seen that it is possible for SIBDOs to be exchanged in a peer-to-peer fashion (i.e. directly between external machines and not via the SIBDO Exchange Server 101), for example over the Internet or by direct file exchange. For example, a SIBDO could be transferred using wireless technology from one mobile device to another mobile device.

The SIBDO Exchange Server 101 is further able to distribute a SIBDO plug-in 130 (or the like i.e. a piece of software that allows SIBDOs 102 to be displayed, manipulated, saved and exchanged within the context of another piece of software such as web browser). In the absence of a dedicated SIBDO enabled application, the SIBDO plug-in 130 enables SIBDOs to be displayed, manipulated, saved and exchanged. For example, e-mail applications, mobile devices and websites that are not SIBDO enabled as part of a dedicated SIBDO application can use the SIBDO plug-in 130 to enable them to interact with SIBDOs. The use of the SIBDO plug-in 120 allows SIBDOs to be used by a large variety of presentation layers and platforms available.

The SIBDO plug-in 130 can also be made available to enable existing providers and vendors of analysis and reporting tools to use their products with SIBDOs.

The interface of a dedicated SIBDO application 120 or SIBDO plug-in 130 has functionality that allows the user to change the way the SIBDO 102 displays the data from the SIBDO Factlets 107, for example by changing the range of data displayed, the display type (text, line graph, bar chart etc.), and so on.

In addition, the interface can be used by a user to combine SIBDOs 102 to form new SIBDOs.

As described above, each original SIBDO 102 will contain code that refers to one or more SIBDO Factlet 104 and defines how data from them should be displayed. The code from each original SIBDO is combined to create a new combined SIBDO, which displays the data displayed by both original SIBDOs in a default display format as described below.

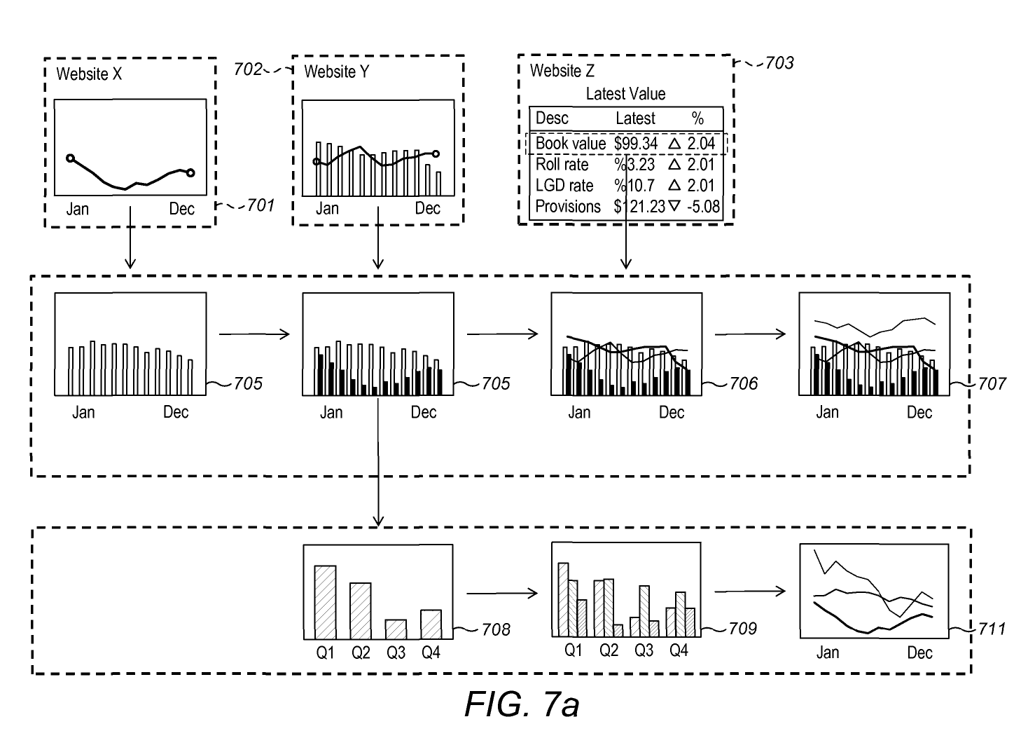

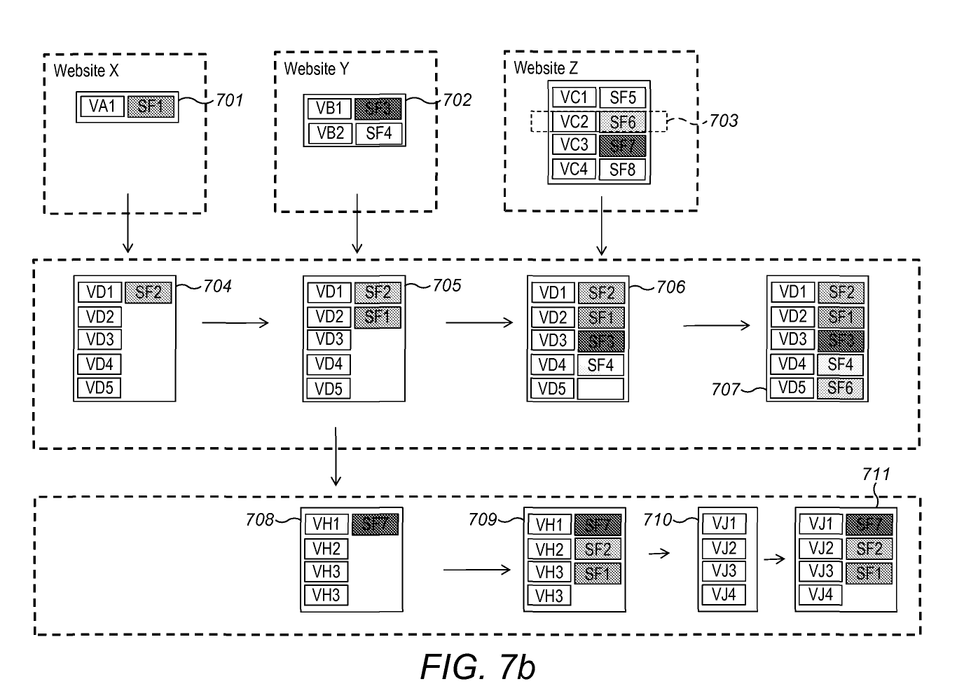

An example of how SIBDOs 102 are combined and shared is now described with reference to FIGS. 7a and 7b. FIG. 7a shows the appearance of the SIBDOs, while FIG. 7b shows their underlying structure.

SIBDO 704 is a SIBDO containing five pre-defined VISO Plots VD1 to VD5. The five VISO plots in order are configured to plot SIBDO Factlet data in the following sequence:
i) VD1: Plot a red bar plot
ii) VD2: Plot a blue bar plot (offset to the right)
iii) VD3: Plot a green line plot
iv) VD4: Plot a blue line plot
v) VD5: Plot a black line plot

Initially SIBDO 704 contains only the single SIBDO Factlet SF2, linked to VISO VD1. The remaining four VISO Plots VD2 to VD5 are not yet linked to a SIBDO Factlet and hence the SIBDO only displays the data for SF2. SIBDO 704 is set to display data in Months.

SIBDO 708 is a SIBDO containing four pre-defined VISO Plots VH1 to VH4. The four VISO plots in order are configured to plot SIBDO Factlet data in the following sequence:
vi) VH1: Plot a red bar plot
vii) VH2: Plot a yellow bar plot (offset to the right)
viii) VH2: Plot a blue bar plot (offset to the right)
ix) VH4: Plot a green bar plot (offset to the right)
Initially SIBDO 708 contains only the single SIBDO Factlet SF7, linked to VISO VH1. SIBDO 708 is set to display data in financial quarters.

SIBDO 701 is a SIBDO containing one VISO Plot VA1 and one SIBDO Factlet SF1. The VISO Plot VA1 has three components drawing the white line plot and two dot end points.

SIBDO 702 is a SIBDO containing two VISO Plots VB1 and VB2 and two respective SIBDO Factlets SF3 and SF4. The VISO Plot VB1 has three components drawing the white line plot and two dot end points, and the VISO Plot VB2 draws a bar plot.

SIBDO 703 is an example of an individual SIBDO contained of a compound SIBDO, in other words one of several individual SIBDOs contained within an outer SIBDO. The individual SIBDOS can be extracted individually and combined with other SIBDOs.

The combining of the SIBDOs via the user interface is as follows.

First, SIBDO 701 is dragged onto target SIBDO 704. The resulting SIBDO 705 displays the SIBDO Factlet VD1 using VISO SF2 as in the target SIBDO 704, and in addition displays SIBDO Factlet SF1 using the next available VISO Plot VD2 (a blue bar plot).

Next, SIBDO 705 is dragged onto target SIBDO 708. SIBDO 708 is displaying SIBDO Factlet SF3 aggregated to financial quarters. The SIBDO Factlets in resulting SIBDO 709 are therefore displayed in the same mode of financial quarters. As before, the resulting SIBDO 709 displays the SIBDO Factlet VH1 using VISO SF7 as in the target SIBDO 708, and in addition displays SIBDO Factlet SF3 and SF4 from SIBDO 702 using the next available VISO Plots VH3 (yellow bar) and VH4 (blue bar).

Next, SIBDO 709 is dragged onto template SIBDO 710. SIBDO 710 has no SIBDO Factlets plotted yet but has VISO Plots VJ1 to VJ4 which display data in plots of type “line” by month. The result is SIBDO 711, in which the SIBDO Factlets SF7, SF2 and SF1 are displayed according to VISO Plots VJ1, VJ2 and VJ3 respectively.

SIBDO 702 is then dragged onto target SIBDO 705. As well as the original display of target SIBDO 705, the resulting SIBDO 706 displays SIBDO Factlets SF3 and SF4 from SIBDO 702 using the next available VISO Plots VD3 (green line) and VD4 (blue line).

Finally, SIBDO 703 (which is contained in a compound SIBDO) is dragged onto target SIBDO 706. The resulting SIBDO 707 displays SIBDO Factlet SF6 from SIBDO 703 using the next available VISO Plots which in this case is VD5 (black line).

In the case that the number of SIBDO Factlets in a SIBDO exceeds the number of preconfigured VISO Plots 105 contained in the SIBDO, the SIBDO Factlets will be rendered with a default plot series, for example, line plots in a predetermined colour series.

When SIBDOs are combined, the dimensions contained in the metadata for each SIBDO are used to determine the ways in which the SIBDOs can be combined, as they can be used to identify which sets of data within the SIBDOs are compatible, and in what ways.

So for example, in the case that the combined VISO displays data in a graph-type format (e.g. as a line graph or bar chart), the units of measure for the underlying SIBDO Factlets will need to be scaled in some way so that the data values can be displayed together. When the units of measure for the data displayed by the original VISOs are the same, the combined VISO will simply display the data from both using the same scale. Further, if the units of measure are different but can easily be converted (for example if a first data trace uses a unit of measure of days, and a second data trace uses a unit of measure of weeks; or for example if the units of measure are kilograms and pounds), the combined VISO displays the two data traces using the same scale by converting the units.

A conversion may also be made using a dynamically changing conversion, which may itself be provided by a SIBDO exchange server 101. For example, a first SIBDO may display historical stock values in GBP, and a second SIBDO historical stock values in USD. The combined SIBDO then converts the values to the same scale using a daily exchange rate, which changes over time. Thus, each time the SIBDO is displayed an up to date exchange rate can be used, without any changes being required by the user.

After the combined SIBDO has been generated with the data displayed in the default manner, if required the interface can then be used by the user to make any changes to the way the data is displayed that are required. For example, the units of measure for the original SIBDOs may be the same, but nevertheless it may not be appropriate to display them using the same scale. For example, it would not be appropriate to display the sales revenue using the same scale as Gross Domestic Product even if both measured using the same unit, GBP.

Once a user is happy with the format of a SIBDO, it can be saved, and made available for use by other users if desired, for example by e-mailing the SIBDO, or by making it available on a website.

In the above embodiment, the combination of SIBDOs is done using the descriptions of data they contain defined using an ontology. For example, a SIBDO may contain data described using a financial ontology, which indicates that a particular set of data in the SIBDO is of the change in an amount in a currency A over time. A second SIBDO contain data described using the same financial ontology may indicate that a particular set of data in the second SIBDO relates to conversion rates from currency A to currency B over time. From this is can be determined that the SIBDOs can be combined to give data for the corresponding change in the amount in the currency B over time.

The data description can also indicate the position of a SIBDO in a hierarchy of SIBDOs, allowing operations spanning multiple SIBDOs to be performed. For example, a “parent” SIBDO may contain total sales data for a company over time, while “child” SIBDOs contain corresponding data for the individual products sold by the company. The data descriptions will define the way in which the SIBDOs relate, allowing (say) a currency change operation on the parent SIBDO to result in a corresponding currency change operation being made on each child SIBDO. Similarly, it can provide the information required to “drill down” from the parent SIBDO to a child SIBDO, or to “roll up” the child SIBDOs into the parent SIBDO.

It is important to note that the SIBDOs can combine multiple dimensions, and not only a single dimension, such as time as in the examples given. For example, two SIBDOs might contain data with dimensions of time, company, product and currency amount, and then when the SIBDOs are combined then each of the dimensions will be combined. The dimensions may also be hierarchical, for example a dimension of country may have a sub-dimension for different companies within the country. Data is commonly organised in such a way using an “OLAP cube”.

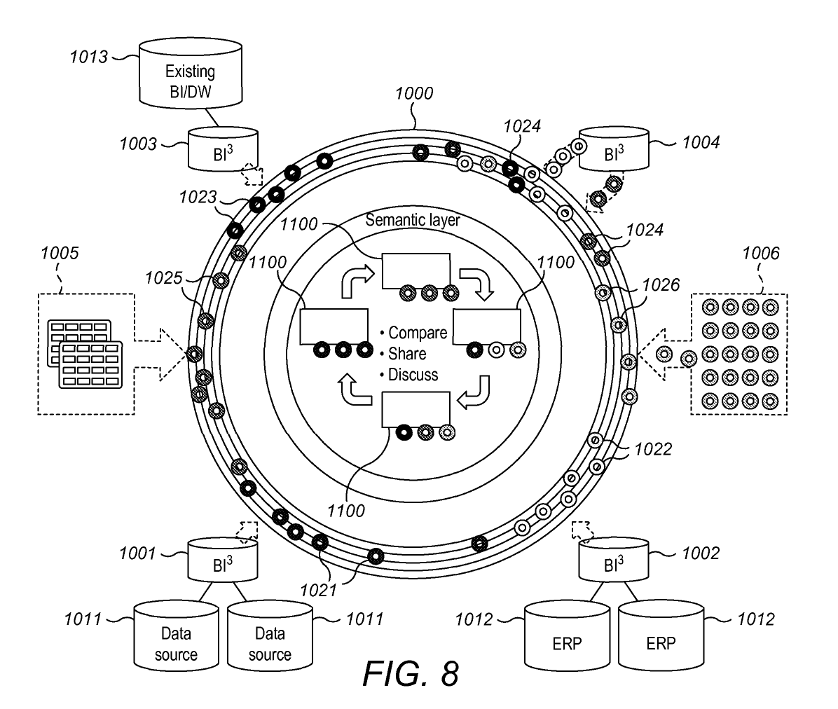

A further schematic diagram of the architecture of the system in accordance with the embodiment of the invention is shown in FIG. 8. The architecture comprises an intranet 1000, for example a company intranet. The intranet 1000 will comprise user devices 1100 which allow users to interact with SIBDOs that are made available on the intranet 1000.

A first server 1001 on the intranet 1000 is connected to data sources 1011, and uses the data from the data sources 1011 to make available SIBDOs 1021. A second server 1002 is connected to enterprise resource management systems 1012 (which aggregate management data such as accounting data, manufacturing data etc.), and uses the data from the enterprise resource management systems 1012 to make available SIBDOs 1022. A third server 1003 is connected to a business intelligence system 1013, and uses the data from the business intelligence system 1013 to make available SIBDOs 1021. Finally, a fourth server 1004 takes existing SIBDOs and generates and makes available new SIBDOs 1024.

Further SIBDOs 1025 are provided from spreadsheets 1005, and SIBDOs 1026 are provided from external data 1006. In both cases, the SIDBOs will be “manually” created by users, as described above.

Thus, it can be seen that the result is an “ecosystem” of SIBDOs made available from many different sources, with different devices generating, combining, analysing and display the SIBDOs (amongst other things).

Whilst the present invention has been described and illustrated with reference to particular embodiments, it will be appreciated by those of ordinary skill in the art that the invention lends itself to many different variations not specifically illustrated herein. It will for example be appreciated by the skilled person that while an embodiment of the invention has been described wherein the invention is implemented using JavaScript, and with reference to web application, the invention is equally applicable to implementations using other systems and languages, for example non-web applications, object systems, .NET, Cocoa, Java and the like, and indeed any other suitable language, environment and/or operating system.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of generating and displaying data display elements in a computer system, wherein a data display element comprises a standardised data set and a display configuration for the data set, wherein the standardised data set comprises a set of data values, and wherein the display configuration defines how the data values making up the standardised data set are displayed, the method comprising the steps of:
displaying a graphical representation of a first data display element using the standardised data set and display configuration of the first data display element;
receiving a request from a user made using the graphical representation of the first data display element to combine the first data display element with a second data display element;
generating a combined data display element comprising a combined standardised data set and a display configuration for the combined standardised data set, wherein the combined standardised data set is generated by combining the sets of data values of the standardised data sets of the first and second data display elements, and wherein the display configuration for the combined standardised data set is derived from the display configuration of at least one of first and second data display elements;
displaying a graphical representation of the combined data display element using the combined standardised data set and display configuration of the combined data display element.

2. The method as claimed in claim 1, wherein the user request to combine the first and second data display elements is made by the user dragging a graphical representation of the second data display element onto the graphical representation of the first data display element.

3. The method as claimed in claim 1, wherein the user request to combine the first and second data display elements is made by the user dragging a saved copy of the second data display element onto the graphical representation of the first data display element.

4. The method as claimed in claim 1, wherein the method further comprises the steps of:
receiving a request from the user made using the graphical representation of a displayed data display element to save a copy of the displayed data display element in a location;
saving a copy of the displayed data display element in the location.

5. The method as claimed in claim 4, wherein the user request to save a copy of the displayed data display element is made by the user dragging and dropping the graphical representation of the displayed data display element onto the location to which the copy is to be saved.

6. The method as claimed in claim 1, wherein the method further comprises the steps of:
receiving a request from the user made to display a graphical representation of a saved copy of a data display element;
displaying the graphical representation of the saved copy of the data display element using the standardised data set and display configuration of the saved copy of the data display element.

7. The method as claimed in claim 6, wherein the user request to display the saved copy of the data display element is made by the user dragging and dropping the saved copy of the data display element onto the location where it is to be displayed.

8. The method of claim 1, wherein the graphical representations of the data display elements are displayed in a web page.

9. The method of claim 1, wherein the generation and display of the data display elements is implemented using JavaScript.

10. The method of claim 1, wherein the standardised data set of at least one data display element is provided by a remote server, and the data display element comprises a link to that server.

11. The method as claimed in claim 10, further comprising the step of updating the data values of the standardised data set by querying the linked server.

12. The method of claim 1, wherein the display configuration of at least one data display element defines that only a portion of the data values making up the standardised data set of the data display element are to be displayed.

13. The method of claim 1, further comprising the steps of:
obtaining a template data display element comprising a display configuration for a standardised data set, but no standardised data set;
obtaining a standardised data set from a server;
including the standardised data set in the template data display element to generate a data display element.

14. The method of claim 1, wherein the standardised data set of a data display element further comprises dimensions for the standardised data set, and wherein the step of generating the combined data display element comprises the step of determining compatible dimensions from the first and second data display elements.

15. The method as claimed in claim 14, wherein the standardised data set of the first data display element comprises a first set of data values described by a first dimension set, the standardised data set of the second data display element comprises a second set of data values described by a second dimension set compatible with the first dimension set, and wherein the combined standardised data set of the combined data display element comprises a third set of data values described by a third dimension set, and the third set of data values is derived from the first and second set of data values, and the third dimension is compatible with the first and second dimension sets.

16. The method of claim 1, wherein the standardised data set of a data display element further comprises units of measure for the data values of the standardised data set, and wherein the display configuration of the combined data display element is derived by converting the units of measure of the data values of the data sets of the first and second data display elements to a common unit of measure.

17. The method as claimed in claim 16, wherein the conversion rate used when converting the units of measure is provided by a remote server.

18. The method as claimed in claim 17, further comprising the step of updating the conversion rate by querying the remote server.

19. A computer system for generating and displaying data display elements, wherein a data display element comprises a standardised data set and a display configuration for the data set, wherein the standardised data set comprises a set of data values, and wherein the display configuration defines how the data values making up the standardised data set are displayed, and wherein the computer system is arranged to:
display a graphical representation of a first data display element using the standardised data set and display configuration of the first data display element;
receive a request from a user made using the graphical representation of the first data display element to combine the first data display element with a second data display element;
generate a combined data display element comprising a combined standardised data set and a display configuration for the combined standardised data set, wherein the combined standardised data set is generated by combining the sets of data values of the standardised data sets of the first and second data display elements, and wherein the display configuration for the combined standardised data set is derived from the display configuration of at least one of first and second data display elements;
display a graphical representation of the combined data display element using the combined standardised data set and display configuration of the combined data display element.

20. The system as claimed in claim 19, wherein the user request to combine the first and second data display elements is made by the user dragging a graphical representation of the second data display element onto the graphical representation of the first data display element.

21. The system as claimed in claim 19, wherein the user request to combine the first and second data display elements is made by the user dragging a saved copy of the second data display element onto the graphical representation of the first data display element.

22. The system of claim 19, further arranged to:
receive a request from the user made using the graphical representation of a displayed data display element to save a copy of the displayed data display element in a location;
save a copy of the displayed data display element in the location.

23. The system as claimed in claim 22, wherein the user request to save a copy of the displayed data display element is made by the user dragging and dropping the graphical representation of the displayed data display element onto the location to which the copy is to be saved.

24. The system of claim 19, further arranged to:
receive a request from the user made to display a graphical representation of a saved copy of a data display element;
display the graphical representation of the saved copy of the data display element using the standardised data set and display configuration of the saved copy of the data display element.

25. The system as claimed in claim 24, wherein the user request to display the saved copy of the data display element is made by the user dragging and dropping the saved copy of the data display element onto the location where it is to be displayed.

26. The system of claim 19, wherein the system is arranged to display the graphical representations of the data display elements in a web page.

27. The system of claim 19, wherein the system is arranged to implement the generation and display of the data display elements using JavaScript.

28. The system of claim 19, wherein the standardised data set of at least one data display element is provided by a remote server, and the data display element comprises a link to that server.

29. The system as claimed in claim 28, wherein the system is further arranged to update the data values of the standardised data set by querying the linked server.

30. The system of claim 19, wherein the display configuration of at least one data display element defines that only a portion of the data values making up the standardised data set of the data display element are to be displayed.

31. The system of claim 19, further arranged to:
receive a template data display element comprising a display configuration for a standardised data set, but no standardised data set;
obtain a standardised data set from a server;
include the standardised data set in the template data display element to generate a data display element.

32. The system of claim 19, wherein the standardised data set of a data display element further comprises dimensions for the standardised data set, and wherein the system is further arranged to generate the combined data display element by determining compatible dimensions from the first and second data display elements.

33. The system as claimed in claim 32, wherein the standardised data set of the first data display element comprises a first set of data values described by a first dimension set, the standardised data set of the second data display element comprises a second set of data values described by a second dimension set compatible with the first dimension set, and wherein the combined standardised data set of the combined data display element comprises a third set of data values described by a third dimension set, and the third set of data values is derived from the first and second set of data values, and the third dimension is compatible with the first and second dimension sets.

34. The system of claim 19, wherein the standardised data set of a data display element further comprises units of measure for the data values of the standardised data set, and wherein the display configuration for the combined data display element is derived by converting the units of measure of the data values of the data sets of the first and second data display elements to a common unit of measure.

35. The system as claimed in claim 34, wherein the conversion rate used when converting the units of measure is provided by remote server.

36. The system as claimed in claim 35, further arranged to update the conversion rate by querying the remote server.

37. A data file for a data display element on a computer system for use in any preceding claim, comprising:
a standardised data set comprising a set of data values;
a display configuration for the standardised data set, wherein the display configuration defines how the set of data values of the standardised data set is to be displayed.

38. A server arranged to store and serve on request data display files as claimed in claim 37.

39. The server as claimed in claim 38, further arranged to store and serve on request template data display elements comprising a display configuration for a standardised data set, but no standardised data set.

40. The server of claim 38, further comprising a data store storing data values, and further arranged to serve, in response to a request for a standardised data set, a set of data values from the data store to make up the standardised data set.

41. A computer program product arranged, when executed, to perform the method of claim 1.

42. A computer program product arranged, when executed on a computer system, to provide a computer system as claimed claim 19.

43. A computer program product arranged, when executed on a computer system, to provide a server as claimed in claim 38.
